(19) United States
(12) Patent Application Publication
(10) Pub. No.: US 2005/0029837 A1
(43) Pub. Date: Feb. 10, 2005

(54) Interior roof lining for a vehicle roof, vehicle roof module, and method of manufacturing

(76) Inventors: Kai Stehning, Usingen (DE); Horst Bohm, Frankfurt (DE)

Correspondence Address: CARLSON, GASKEY & OLDS, P.C., 400 WEST MAPLE ROAD, SUITE 350, BIRMINGHAM, MI, 48009, US

(21) Appl. No.: 10/889,446

(22) Filed: Jul. 12, 2004

(30) Foreign Application Priority Data
Aug. 8, 2003 (DE) 103 36 583.4

(51) Int. Cl. B60R 13/02

(52) U.S. Cl. 296/214

(57) ABSTRACT

A vehicle interior roof lining has fastening protrusions that fasten the interior roof lining to an outer skin of a vehicle roof. The fastening protrusions attach the interior roof lining to the outer skin at singular areas and not across the entire available surface area of the interior roof lining. The fastening protrusions also space the remaining, unattached areas of the interior roof lining away from the outer skin. The protrusions allow the interior roof lining to be fastened and removed easily. The invention also relates to a method of producing the interior roof lining and a roof module having the interior roof lining.

### REFERENCE TO RELATED APPLICATIONS

The present invention claims the benefit of German Patent Application No. 103 36 583.4, filed Aug. 8, 2003.

### TECHNICAL FIELD

The invention relates to a vehicle interior roof lining having an inner side facing a vehicle interior and an outer side facing an outer skin of a vehicle roof.

### BACKGROUND OF THE INVENTION

Interior roof linings are used in vehicles to cover an outer skin of a vehicle roof on a side facing a vehicle interior. The outer skin is usually is made of sheet metal or plastic. The interior roof lining is firmly attached to the vehicle roof skin so that it will not vibrate excessively as the vehicle is driven. The interior roof lining is also designed to accommodate other vehicle components, such as lighting, storage spaces, sunshades and the like. Currently known interior roof linings are usually glued across a large surface area on an inside surface of the outer skin. This provides a secure connection between the interior roof lining and the outer skin. However, it is very difficult to remove and exchange the interior roof lining during repair.

German Patent No. DE 100 19 199 C2 and U.S. Pat. Publication No. 2001/0051245 describe an interior roof lining having a punched raster foil to make it easy to remove and exchange. However, this configuration can be expensive to manufacture.

There is a desire for an interior roof lining that can be produced economically and that also can be easily removed from an outer skin for replacement.

### SUMMARY OF THE INVENTION

A vehicle interior roof lining according to one embodiment of the invention includes at least one singular fastening protrusion formed on an outer side of the interior roof lining. The fastening protrusion is used to fasten the interior roof lining to an outer skin of a vehicle roof. As a result, the inventive interior roof lining is attached to the outer skin via fastening protrusions at singular areas of the interior roof lining and not across the entire available surface area of the interior roof lining. The fastening protrusions also space the remaining, unattached areas of the interior roof lining away from the outer skin. The number, position and support surface configuration of the fastening protrusions on the interior roof lining allow the interior roof lining to be fastened in a reproducible manner to the outer skin and to be easily removed as well.

The invention further relates to a method of producing a vehicle roof comprising the outer skin and the interior roof lining that is capable of being fastened to the inner side of the outer skin via the fastening protrusions. The interior roof lining is fastened to the roof skin via external faces of the fastening protrusions by an adhesive or other suitable means. In other words, only the fastening protrusions of interior roof lining are attached to the outer skin with the adhesive, leaving other portions of the interior roof lining free.

The invention also relates to a vehicle roof module produced according to the inventive method.

### BRIEF DESCRIPTION OF THE DRAWINGS

Further features and advantages will be apparent from the following description and the following drawings to which reference is made and in which:

FIG. 1 is a top view of a vehicle interior roof lining according to one embodiment of the invention; and

FIG. 2 is a cross-sectional view of a vehicle roof having the interior roof lining shown in FIG. 1.

### DETAILED DESCRIPTION OF THE EMBODIMENTS

Generally, the invention is directed to a vehicle interior roof lining configuration having a plurality of singular fastening protrusions formed on an outer side of the interior roof lining. The fastening protrusions are used to fasten the interior roof lining to an outer skin of a vehicle roof.

Thus, the interior roof lining according to the invention is fastened to the outer skin through the fastening protrusions on the interior roof lining and not across an entire available surface area of the interior roof lining. Moreover, the fastening protrusions space discrete areas of the interior roof lining away from the outer skin. The number, position and support surface configuration of the fastening protrusions on the interior roof lining are selected according to the particular respective requirements and circumstances of the vehicle roof and allow the interior roof lining to be fastened to and removed from the outer skin in a reproducible manner.

In one embodiment, the interior roof lining is a laminated composite part, with the fastening protrusions being formed in an external layer of the composite part. The external layer may be a foamed plastic layer, which allows the fastening protrusions to be produced in a simple manner. The fastening protrusions may be formed in the composite part by depressions in a foaming tool, which delimit the fastening protrusions between them. The foaming process allows the fastening protrusions to be adapted to any desired configuration at a high level of customization. The fastening protrusions themselves can be, for example, configured to different depths, diameters and/or geometries.

In one embodiment, the fastening protrusions are disposed on the edge of the interior roof lining as well as in the middle of the interior roof lining.

The invention further relates to a method of producing a vehicle roof comprising an outer skin and an interior roof lining designed to be fastened to an inner side of the outer skin. The interior roof lining is fastened to the roof skin at external faces of the fastening protrusions by, for example, an adhesive or other attachment means. The outer edges of the outer skin and the interior roof lining can be attached together with clamps or other known mechanisms.

Note that not all of the protrusions on the outer side of the interior roof lining need to be configured as fastening protrusions. For example, it is also possible to include positioning protrusions that rest on the outer skin and position the interior roof lining horizontally and/or vertically with respect to the outer skin. Many variations are possible; for example, the positioning protrusions can act as stops or spacers that are not glued to the outer skin.

Moreover, a geometry may be formed on an inner side of the outer skin to act as a lateral stop for a penetrating protrusion on the interior roof lining. In one example, an internal reinforcement spar in the outer skin may serve as a stop for the positioning protrusion. The reinforcement spar, which is already an existing part of the outer skin, is therefore given an additional function when considered with the penetrating protrusion. Thus, the positioning protrusions and the penetrating protrusions on the interior roof lining and the geometry on the outer skin act as installation aids that allow a quick alignment of the interior roof lining with respect to the outer skin.

The invention also relates to a vehicle roof module produced according to the inventive method.

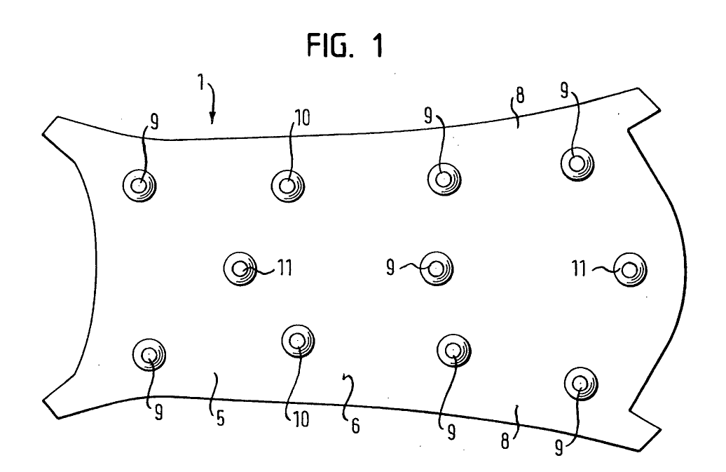

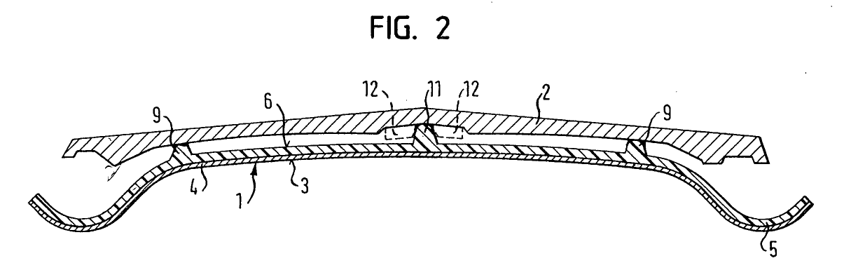

Referring now to the drawings, FIG. 1 illustrates one example of a vehicle interior roof lining 1 that is formed as a laminated composite part. FIG. 2 illustrates an example of a vehicle roof module with the interior roof lining 1 installed. The roof module is designed to be fastened to a roof frame (not shown). As shown in FIG. 2, the roof module includes an outer skin 2 and the interior roof lining 1. The outer skin 2 may be made of any desired appropriate material, such as glass, sheet metal or plastic.

The interior roof lining 1 has a substrate 3 facing a vehicle interior. This inner side 3 is formed by a film or a textile 4. A foamed backing forms a foamed plastic layer 5 on a rear side of the interior roof lining 1. The side of the interior roof lining 1 facing the outer skin 2 is called an outer side 6.

As shown in FIG. 1, the outer side 6 is formed entirely by the foamed plastic layer 5. The foamed plastic layer 5 has a plurality of generally dome-shaped or tapered, singular fastening protrusions 9 that project upward from the outer side 6 of the interior roof lining 1. In the illustrated example, the fastening protrusions 9 are disposed near edge portions 8 of the interior roof lining 1 and a middle portion of the interior roof lining. In one embodiment, the fastening protrusions 9 are formed as integral parts of the foamed plastic layer 5.

The interior roof lining 1 is connected to the outer skin 2 only by the fastening protrusions 9 and not over an entire surface area of the interior roof lining 1. In one embodiment, the end faces of the fastening protrusions 9 are glued or otherwise attached to a inside surface of the outer skin 2.

Some of the protrusions provided on the outer side 6 and formed in the foamed plastic layer 5 can also have positioning functions. The example shown in FIGS. 1 and 2 illustrate positioning protrusions 10 and penetrating protrusions 11, both of which serve positioning functions. The positioning protrusion 10 has a geometry that is identical to the fastening protrusions 9, but it is not glued to the outer skin 2. Instead, the positioning protrusion 10 acts as a stop or spacer because it simply rests on the outer skin 2 rather than being attached to it.

The penetrating protrusion 11 not only provides vertical positioning of the interior roof lining 1, but also provides horizontal (i.e. lateral) positioning of the interior roof lining 1 with respect to the outer skin 2. The outer skin 2, which in this case is preferably made of metal, has an optional internal reinforcement spar 12 made of deformed sheet metal. This reinforcement spar 12 is illustrated with dotted lines in FIG. 2. The reinforcement spar 12 has holes designed to accommodate an outer cross-section of the penetrating protrusions 11. For example, the penetrating protrusions 11 and the holes in the reinforcement spar 12 may both have corresponding (e.g., generally dome-shaped, conical) profiles. The penetrating protrusion 11 penetrates the reinforcement spar 12 to position the interior roof lining 1 with respect to the outer skin 2. In one example, there is a small clearance between the edge of each hole in the reinforcement spar 12 and its associated penetrating protrusion 11 to provide a weak press fit.

During installation of the interior roof lining 1 to the outer skin 2, selected surfaces of the fastening protrusions 9 may be coated with adhesive. When the interior roof lining 1 is attached to the outer skin 2, the penetrating protrusions 11 penetrate corresponding holes in the reinforcement spar 12 to provide a simple and secure positioning of the interior roof lining 1 to the outer skin 2. This simple attachment structure is particularly advantageous in allowing easy repair and replacement of the interior roof lining 1. Note that the positioning protrusions 10 and the penetrating protrusions 11 may also act as fastening protrusions if they are provided with adhesive to attach to the outer skin 2.

Note that the outer skin 2 does not need to have the reinforcement spar 12 or any openings to accommodate the positioning protrusions 10 or the penetrating protrusions 11. Other geometries in the outer skin 2 may act as stops in the vertical and/or horizontal directions.

The inventive interior roof lining 1 structure makes repair easier because the interior roof lining 1 can be detached from the outer skin 2 easily and completely, making fastening of the new interior roof lining 1 easier as well.

It should be understood that various alternatives to the embodiments of the invention described herein may be employed in practicing the invention. It is intended that the following claims define the scope of the invention and that the method and apparatus within the scope of these claims and their equivalents be covered thereby.

1. A vehicle interior roof lining comprising:
an inner side facing a vehicle interior and an outer side facing an outer skin for a vehicle roof; and
at least one fastening protrusion disposed on the outer side, wherein the interior roof lining is to be fastened to the outer skin by said at least one fastening protrusion.

2. The interior roof lining according to claim 1, wherein the interior roof lining is a laminated composite part having an external layer, and wherein said at least one fastening protrusion is formed in the external layer.

3. The interior roof lining according to claim 2, wherein the external layer is a foamed plastic layer.

4. The interior roof lining according to claim 1, wherein said at least one fastening protrusion is integral with the outer side of the interior roof lining.

5. The interior roof lining according to claim 1, wherein said at least one fastening protrusion comprises a plurality of fastening protrusions disposed near an edge of the interior roof lining and in a middle of the interior roof lining.

6. The interior roof lining according to claim 1, wherein the fastening protrusions are generally dome-shaped.

7. The interior roof lining according to claim 1, further comprising at least one of a positioning protrusion and a penetrating protrusion disposed on the outer side.

8. The interior roof lining according to claim 7, wherein said at least one positioning protrusion has an identical shape as said at least one fastening protrusion.

9. A method of manufacturing a vehicle roof module having an outer skin and an interior roof lining having at least one fastening protrusion with an external face, comprising:
aligning an inner surface of the outer skin with the external face of said at least one fastening protrusion; and
fastening the external face of said at least one fastening protrusion to the inner surface of the outer skin.

10. The method according to claim 9, wherein the fastening step comprises applying an adhesive to the external face of said at least one fastening protrusion.

11. The method according to claim 9, wherein the adhesive is applied only to the external face of said at least one fastening protrusion.

12. The method according to claim 9, wherein the interior roof lining further comprises at least one positioning protrusion, and wherein the method further comprises positioning the interior roof lining in at least one of a horizontal direction and a vertical direction using said at least one positioning protrusion, wherein said at least one positioning protrusion rests on the outer skin.

13. The method according to claim 9, wherein at least one geometry is formed on the inner side of the outer skin, and wherein the method further comprises fastening at least one penetrating protrusion to the geometry such that the geometry serves as a lateral stop for said at least one penetrating protrusion when the inner lining is fastened to the outer skin.

14. The method according to claim 13, wherein the step of fastening said at least one penetrating protrusion to the geometry is conducted via a press fit.

15. The method according to claim 9, further comprising forming the interior roof lining as a laminated composite part by forming a backing on a substrate, wherein said at least one fastening protrusion is integrally formed in the backing.

16. The method according to claim 15, wherein the forming step comprises foaming a plastic material to form the backing and said at least one fastening protrusion.

17. A vehicle roof module, comprising:
an outer skin; and
an interior roof lining having:
a substrate facing a vehicle interior and a backing having an outer side facing the outer skin, and
at least one fastening protrusion disposed on the outer side of the backing, wherein the interior roof lining is fastened to the outer skin by said at least one fastening protrusion.

18. The vehicle roof module according to claim 17, wherein said at least one fastening protrusion comprises a plurality of fastening protrusions disposed near an edge of the interior roof lining and in a middle of the interior roof lining.

19. The vehicle roof module according to claim 17, further comprising at least one of a positioning protrusion and a penetrating protrusion disposed on the outer side of the backing.

20. The vehicle roof according to claim 19, wherein the outer skin includes a reinforcement spar that accommodates the penetrating protrusion, wherein the penetrating protrusion penetrates the reinforcement spar.
